(19) United States
(12) Patent Application Publication
(10) Pub. No.: US 2008/0137791 A1
(43) Pub. Date: Jun. 12, 2008

(54) Device for the Endogenous Production of Radioisotopes, Particularly for Pet

(76) Inventors: Marco Sumini, Alessandria (IT); Agostino Tartari, Mirandola (IT); Domiziano Mostacci, San Benedetto Val Di Sambro (IT)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/666,104

(22) PCT Filed: Oct. 21, 2005
(86) PCT No.: PCT/EP05/11353

§ 371 Date: Jun. 6, 2007

(30) Foreign Application Priority Data
Oct. 21, 2004 (IT) VE2004A000038

(51) Int. Cl. H05H 1/22

(52) U.S. Cl. 376/126

(57) ABSTRACT

Device for the endogenous production of radioisotopes, particularly for PET, characterized by comprising: a vacuum chamber (1), the inner surface of which at least partially treated to resistion implantation and inertised with respect to the nuclear reaction products,—a pair of electrodes (4, 5) placed inside said vacuum chamber (1),—a capacitor bank (2),—means (3,16) to connect said capacitor bank (2) to said electrodes (4,5) to generate between the latter an electrical discharge, thus generating plasma and creating conditions for the unfolding of nuclear reactions that generate radioisotopes,—an overall inductance of the equivalent electric circuit of such device not exceeding 50 Nh—means (10) attached to said vacuum chamber (1) for the creation of a vacuum not higher than 10⁻⁶ torr—means (11) attached to said vacuum chamber (1) for the insertion, after creating the vacuum, of at least one reaction gas at a pressure apt to guarantee creation of the plasma during discharge and subsequent obtainment of confinement conditions of such plasma of the order of 10¹⁵ keV-s/cm3, and—means attached to said vacuum chamber (1) for the extraction of gas and its storage into a gas-chromatographic cylinder.

The present invention concerns a device for the endogenous production of radioisotopes, particularly for PET.

Positron Emission Tomography (PET) is known to represent, at present, the most advanced technique for investigating physiological and physio-pathological processes in vivo. In its general aspect, it is a three-dimensional scanning of the patient with detection of radiation emitted due to the injection of specific radioisotopes conveyed by radiopharmaceuticals to the organs under scrutiny.

In recent years PET has witnessed marked technological improvements. Among them one can mention integrated multi-modal PET/CAT systems, powerful software for image processing, and the development of tri-dimensional acquisition techniques (3D).

The tri-dimensional acquisition mode (PET3D), developed in the first half of the 90's, rests on the detection of all coincidence lines, including those slanted with respect to the detection axial planes: it yields a significant increase in the detection efficiency, by a factor of 5 at least, compared to the previous two-dimensional mode, leading to a significant improvement in the S/N ratio in PET images, which is of primary importance in total-body studies with ¹⁸F-FDG (Fluorine-Deossi-Glucose marked with ¹⁸Fluorine).

Image reconstruction has benefited from iterative numerical techniques yielding many advantages: improvement in the anatomical localization and the spatial definition of the tumor, compensation of geometric distortion (a mandatory pre-requisite to the integration with CAT images), and quantification of the tracking particle capture process.

There are known integrated PET/CAT systems also, including both a PET and and a CAT tomography in a single step, controlled from a single console, and attached to a single patient bed. Those systems permit to acquire PET and CAT images in a single examination, with reduction of examination time and, thanks to synergic use of images, a better integrated diagnosis. Thanks to these improvements, PET/CAT exams have become the excellence technique for early diagnosing of tumors, for the analysis of pathologies of the heart and brain, and for the investigation of physiological and physio-pathological processes in vivo at large.

At present, the positron emitting radioisotopes needed for PET/CAT exams are produced in compact cyclotrons, capable of accelerating protons and deuterons which, impinging on appropriate targets, give rise to nuclear reactions with generation of ¹¹C, ¹³N, ¹⁵O or ¹⁸F. Known examples of compact cyclotrons are MINitrace and PETtrace by General Electric, the TR series by EBCO and the Cyclone series by IBA.

The MINitrace system, in particular, has the following characteristics:
proton acceleration up to 9.6 MeV;
integrated radiation protection screen;
vertical magnet;
50 kVA power supply;
control and diagnosis system run from a workstation.

The PETtrace system (a 16.5 MeV negative ion isochronous cyclotron, proton and deuteron accelerator) requires instead 130 kVA, an area of no less than 80 m², inclusive of ancillaries, and weighs 25-27 metric tons.

Production rate for the PETtrace system is approximately 3 Ci/hour.

The Cyclone 18/9 by IBA (18 MeV proton, 9 MeV deuteron compact cyclotron) with titanium target has the following characteristics:

| | | |
|---|---|---|
| Energy: | 18 | MeV |
| Beam intensity | 37 | μA |
| Irradiation time | 120 | min |
| Thick target yield | 234 ± 10 | mCi/μA · sat |
| Radioactivity | 4.6 ± 0.2 | EOB (Ci) |

The main limitation in PET diagnosis systems is the need for radiation emitters with very short-lived nuclides, importing fast disintegration after production, making them useless in a short time.

The present solution to this problem is to have the cyclotron located near the PET center to produce the radioisotopes on location.

This solution has problems of several natures: economic, management and radiation protection.

From the economics standpoint, the cost of a small cyclotron, including all the structures and ancillary systems it requires, runs in the 4 to 5 million euros. As far as radiation protection is concerned, the intense radiation fields around the machine require demanding structures (concrete walls, as thick as 200 cm, depending on the machine), and the great radiological hazard of such systems requires adequate design of all technical systems connected to the plant (air change, electrical, fire protection . . . ). From a management point of view a cyclotron is always subjected to radiation protection legislation mandating central government authorization (Ministries and Agencies responsible for environmental protection), in turn requiring long and demanding procedures. Furthermore, the complex architecture of the device (magnet, radiofrequency, ion source, extraction systems, and vacuum, control and cooling systems, targets) requires continuous, 24 hour operation, even when not in production. Any shutdown, including those frequently needed for maintenance, imports a long and complex transient to recover optimal operating conditions, with the ensuing interruption of diagnostic activity.

Another present-day known solution calls for acquiring the radioisotopes from external suppliers, but this too has problems. First and foremost, the need for short lived radioisotopes forces to acquire much larger quantities than needed for the day, to make up for their fast disintegration, and the use of very short lived radioisotopes is completely ruled out. For instance, ¹⁵O has a half life of 122 s, meaning that after just 20 min form production activity is reduced by a factor of 1/1000. If one wanted to use it after 20 min from production, 1000 times the amount needed should be acquired.

Secondly, transporting the radioisotopes from production to utilization location requires severe safety measures, to prevent radiation and environmental hazard, not to mention accidents and terroristic action.

Finally, the ever existing possibility of supply interruption (maintenance . . . ) may stop activity, with the obvious negative impact of both medical (exam cancellation) and economical nature.

In light of this state-of-the-art, the main problem this invention intends to tackle and solve is that of proposing a device capable of being a valid and advantageous alternative to cyclotrons in the production of short lived radioisotopes, and of eliminating the problems presented by cyclotrons.

Generally speaking, radioisotope production can be achieved through two different modes, termed endogenous (if production takes place within the plasma inside the device) and exogenous (if it takes place in a target outside the plasma).

The present invention concerns a device for the endogenous production of radioisotopes, particularly for PET, as described in claim 1.

In the following, the present invention is further clarified in one preferred practical form of its implementation, described purely as a clarifying but not limiting example, with reference to the drawings attached, where:

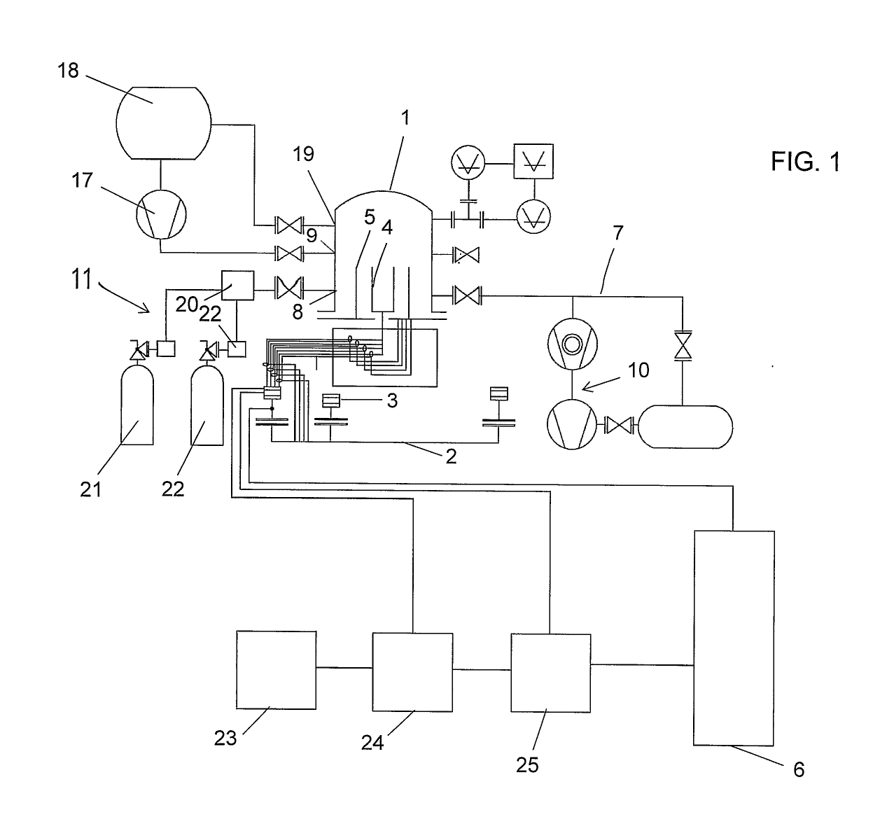

FIG. 1 shows a general schematic view of the invention,

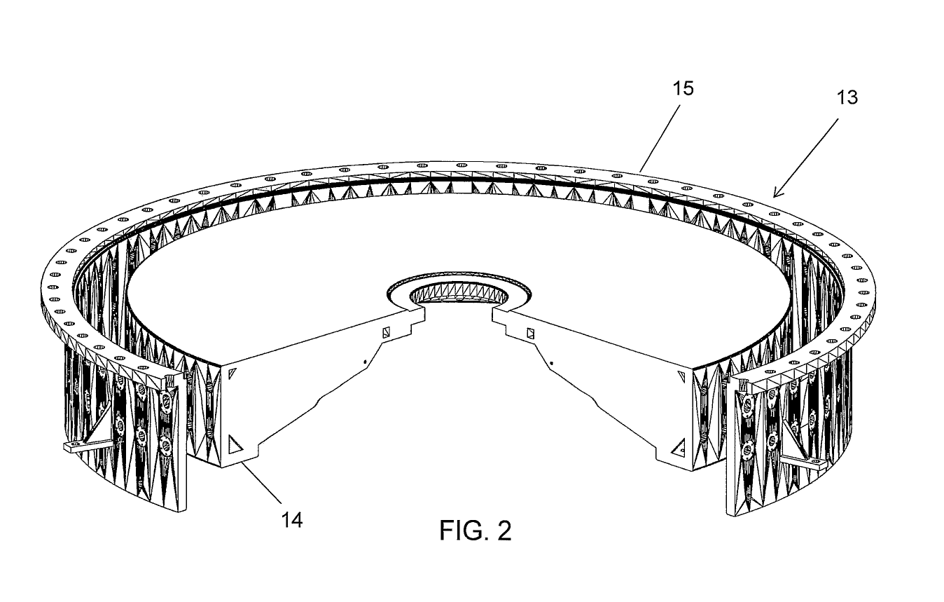

FIG. 2 shows a fragmented axonometric view of the detail of the connector of the capacitor bank to the electrodes,

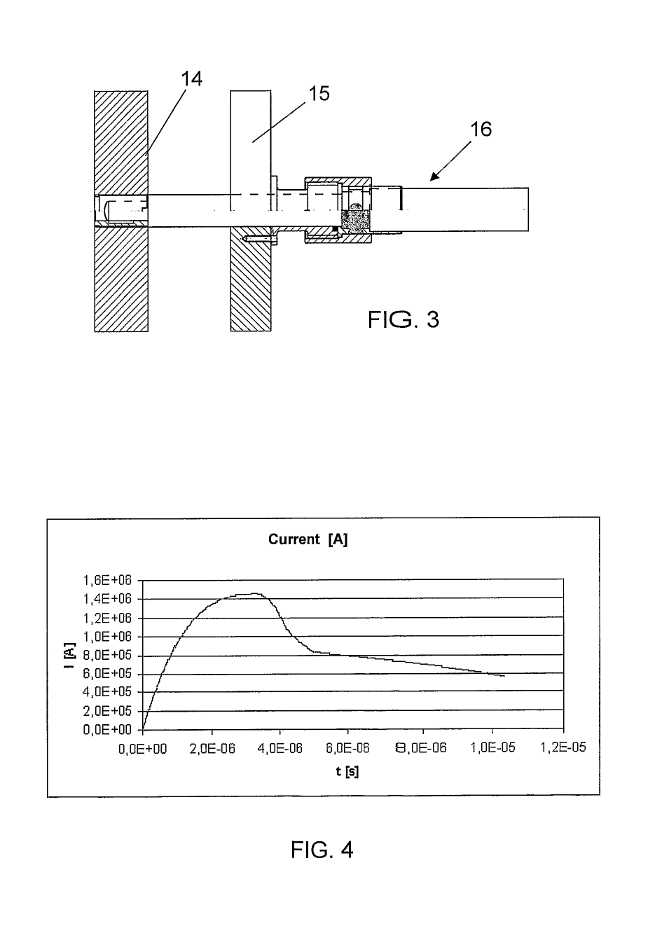

FIG. 3 shows a detail thereof, the connection of a coaxial cable to the collector, and

FIG. 4 shows a plot of the discharge current between the electrode in an instance of experimental realization of such device, and

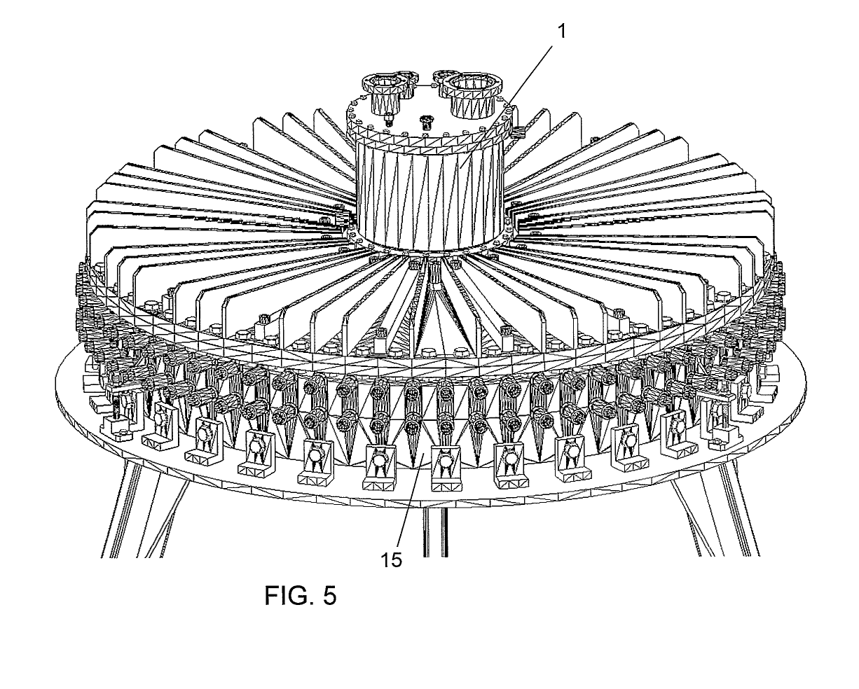

FIG. 5 shows an axonometric view of the collector-chamber assembly.

With reference to FIG. 1, the device according to the invention may be defined as a machine operating in pulsed mode, capable of generating, accelerating and confining plasma, in which under appropriate conditions thermonuclear reactions take place conducive to the production of short-lived, positron emitting radioisotopes.

The machine comprises a bank of parallel connected, high voltage, high current capacitors 2, a number of high voltage, high current fast switches 3, two cylindrical, coaxial electrodes 4, 5, located inside a high vacuum chamber 1, a power supply 6 to charge the capacitors 2, and a high voltage, high current transmission line electrically connecting the capacitors 2 to the electrodes 4, 5 through the fast switches 3.

The vacuum chamber 1 has preferably cylindrical form, with a bottom base connected to the upper side of the collector and to the external (negative) electrode 5, and the top base closed by a plane flange or a spherical shell. To said bottom base, connected to the upper side of the collector, is attached, through appropriate insulating means, the inner electrode 4, in turn electrically isolated from the external electrode 5 through appropriate insulating means, for instance a ceramic material at closed porosity containing at least 95% of Al₂O₃.

The vacuum chamber is equipped with a water cooling system. The inner surface of the vacuum chamber 1 is treated totally or partially (i.e. the upper flange only) so as to avoid attachment of the produced isotopes; more specifically, it is lined with materials that avoid chemical attachment and ionic implantation, for instance ceramic materials, or heavy metals (nickel) or of the group of vanadium and particularly vanadium itself, tantalum or tungsten.

The vacuum chamber 1 presents openings 7,8,9 to connect, respectively, the vacuum system 10, the system 11 to introduce the reacting gases, and a system for the extraction of reaction products.

Another opening 19 serves the purpose of reintroducing in the vacuum chamber 1 gas that had been extracted from the chamber with a pump 17 and filtered through filter 18 to allow the chemical capture of the radioisotopes.

To every fast switch electronic 23 is associated to control a trigger 24 and a system 25 for the introduction of cooling and working fluids like dry air, sulphur exafluoride and deionized water.

The connection between fast switches 3 and electrodes 4,5 is obtained through coaxial cables 16 at very low inductance and a specifically designed metal collector 13 (preferably steel or copper-beryllium). This latter is made of two parts, the external one electrically grounded and the inner one electrically charged: each part is made of a cylindrical ring connected to a circular slab; the two slabs have the same symmetry axis and are separate by a layer of dielectric material 1 cm thick (f.i. Delrin); the two rings are separated by an air gap of 10 cm. The mechanical stiffness of the two slabs is also enhanced with suitable vertical metallic elements able to protect the whole structure from the electrodynamic forces coming from the discharge process and also limit the relative displacements. The two slabs also work as support for the water cooling system.

The connection with the capacitor bank is effected with coaxial cables 16 whose shield is connected to the external element 15 of the collector and whose inner lead crosses said external element and is connected to inner element 14. The electrical connection occurs through connectors able to guarantee a minimal electrical resistance and ohmic heating.

The operation of the device according to the invention is now described with reference to a single pulse, albeit repetitive operation, at a frequency of 1 Hz, appears more suitable to the production of sizeable quantities of radioisotopes.

A single pulse of operation of the device comprises charging the bank capacitors 2 at the selected voltage, then discharging rapidly (in a few microseconds) on the electrodes 4,5 the energy so stored in the bank.

However, before discharging it is necessary to create vacuum inside the chamber 1, which is effected connecting the chamber to the vacuum pump 10 through the opening 7.

After reaching the required vacuum, which is monitored with an appropriate system and which must not exceed 10⁻⁶ torr, the vacuum pump 10 is stopped and the reaction gas is introduced in the chamber 1 through opening 8.

The system 11 for the introduction of reaction gases includes preferably a mixer 20, to which are attached pipes coming form bottles 21, 22 containing the reaction gases in the purest form.

The pressure of the reaction gas or mixture of reaction gases inside the chamber 1 is a function of the reaction gas used and must be of the order of 10 torr.

The discharge of capacitors 2 produces ionization of the gas between the electrodes 4 and 5, its transition to the state of plasma and its movement toward the end of the electrodes.

The total current flowing in the discharge process may reach 3 MA.

Once it reaches the end of the electrodes, the plasma is compressed by the intense magnetic fields that arise, so reaching the confinement conditions typical of thermonuclear plasmas, and corresponding to a combination of density, energy and confinement time of the plasma particles of the order of 10¹⁵ keV·s/cm³.

After a few tens of nanoseconds the process comes to an end and inside the vacuum chamber 1 there exists reaction gas containing the radioisotopes of interest.

Its extraction from the vacuum chamber 1 through the opening 9 can be effected pneumatically or cryogenically. In the former case the gas is extracted by a pump system or pushed out of the chamber by fresh gas introduced through opening 8; in the latter case, the gas is cooled, preferably with a cooling circuit through liquid nitrogen, so as to obtain its condensation and then extraction in liquid form. This latter case requires a more complex device, due to the need to equip the vacuum chamber with a cooling circuit, but it guarantees the total extraction of the gas containing the radioisotopes.

As stated previously, once the gas is extracted from the vacuum chamber 1, it can be filtered so as to extract the radioisotopes and reintroduce the clean gas in the vacuum chamber.

After a given number of discharges the vacuum chamber 1 is given a complete wash out.

The nuclear reaction that can be exploited in the device according to the invention are, for instance, the following:
12C(3He,n)14O
12C(3He,d)13N
12C(3He,4He)11C
14N(3He,d)15O
14N(3He,4He)13N
12C(3He,n)14O
16O(3He,p)18F
16O(3He,4He)15O
12C(d,n)13N
14N(d,n)15O
16O(d,n)17F
17O(d,n)18F
3He(d,p)4He

The device according to the invention is noticeably more advantageous than traditional devices for the production of radioisotopes, and particularly:
its cost is less than a fourth of that of a small cyclotron,
with some of the aforementioned reactions no neutrons are produced, thus eliminating problems and costs connected with shielding and usual radiation protection measures,
radioisotopes may be obtained with high purity,
radioisotopes are obtained in gaseous form, suitable for the production of radiopharmaceuticals,
various different radioisotopes can be produced,
it can be installed in close proximity of the radiochemistry hall connected with a PET station.

The following example, referring to a device for the production of ¹⁸F and ¹⁵O, will help to clarify further the invention.
A device has been constructed with the following design data:

| | |
|---|---|
| Charging voltage | V₀ = 30 kV |
| Maximum total inductance | L_{T} = 40 nH |
| Peak total current | I_{T} = 1 ÷ 3 MA |
| Total resistance | R_{T} = 1 ÷ 10 mΩ |
| Total bank energy | E_{T} = 150 kJ |
| Repetition frequency | ν = 1 Hz |

Each of the capacitor in the bank had the following specifications:

| | |
|---|---|
| Model | GA 32899 |
| Capacity | C = 11 μF |
| Maximum working voltage | Vₘₐₓ = 36 kV |
| Maximum damage voltage | V_{dmage} = 40 kV |
| Peak working current | I_{C} = 150 kA |
| Working voltage reversal | 60% |
| Maximum voltage reversal | 80% |
| Life cycles in work conditions | 1E6 |
| Inductance | L_{C} = 30 nH |
| Dimensions | 31 × 41 × 68 cm |
| Weight | 140 kg |

Given that design requirements for the power supply were:

| | |
|---|---|
| Voltage | V₀ = 30 kV |
| Deliverable energy | 157.5 kJ (per cycle) |
| Bank charging time | τ_{c} = 1/ν = 0.5 ÷ 0.8 s |
| Average deliverable current | I_{PS} = Q_{T}/τ_{c} = 12 ÷ 22 A |
| Peak deliverable power | P_{PS} = I_{PS} V₀ = 360 ÷ 660 kVA |

A power supply was procured having the following specifications:

| | |
|---|---|
| Deliverable energy | 157.5 kJ (per cycle) |
| Bank charging time | τ_{c} = 1/ν = 0.8 s |
| Average deliverable current | I_{PS} = Q_{T}/τ_{c} = 12 ÷ 14 A |
| Peak deliverable power | P_{PS} = I_{PS} V₀ = 360 ÷ 420 kVA |

The power supply can be run in both single pulse and repetitive mode, in the latter case making use of the timings of the trigger unit for the fast switch 3.

The fast switch 3 had the following specifications:

| | |
|---|---|
| Model | REB3 SG-183 Montecuccolino type |
| | (i.e., designed specifically by |
| | R. E. Beverly III & Ass.) |
| Triggering type | field distortion |
| Minimum working voltage | 15 kV |
| Maximum working voltage | 65 kV |
| Working peak current | I_{SG} = 160 kA |
| Maximum peak current | 250 kA |
| Maximum transferred charge | 0.36 C per shot |
| Inductance | L_{SG} = 27 nH |
| Closing time | 22 ns |
| Breakdown time | 600 ns |
| Working gas | Ar, Ne, H₂, N₂, synthetic |
| | Air, compressed air (with |
| | different performances |
| Output to the device | 4 coaxial cables per switch |
| Coaxial cables | Dielectric Science DS 2248 |

The device had a system for the cooling of the electrodes, a system for the recirculation of gas in the vacuum chamber and one for the recirculation of gas in the fast switches, also designed to cool the switches, that permitted functioning at 1 Hz repetition mode.

The inductance of a single unit, comprising a capacitor and a fast switch was L_{C}+L_{SG}=57 nH. If L_{cable} is the average inductance of one coaxial cable (dependent on cable diameter and length, and hence on the geometry of the device) the total inductance L upstream of the electrodes was

$$L = \frac{57 + \frac{{L}_{cable}}{4}}{32} = 1.8 + \frac{{L}_{cable}}{128} nH$$

Capacitors were parallel connected during charge, through a distribution box incorporating appropriate noise suppression snubber circuitry with high voltage diodes.

The coaxial cables 16 connecting the 32 capacitors to the collector, in turn connected with the electrodes 4,5, were 128, and each one carried a maximum current of 25 kA, that is ¼ I_{Cmax}.

Each coaxial cable was approximately 1.5 m long.

The collector consisted of an external ring 28.5 high with 16 cm radius.

The vacuum chamber was built in stainless steel and the inner surface of the upper flange has been coated with a nickel layer with inertisation purposes.

Its shape was cylindrical, with a volume of 30 liters, strictly the minimum volume needed, so as to avoid unnecessary waste of ³He.

Electrodes were dimensioned with a simulation code. Input parameters for the simulations were the circuit total resistance, the total inductance upstream of the electrodes, and the gas type and pressure. Aim of the simulation was finding the conditions that maximized the current peak, with the condition of time coincidence with the pinch. The following parameters were adopted:

| Circuit resistance | 10 | mΩ |
|---|---|---|
| Inductance upstream of electrodes | 25 | nH |
| Gas | D₂ | |
| Pressure | 10 | torr |

FIG. 4 shows a typical plot of the discharge current. A current maximum of approximately 1450 kA can be recognized around time t=3.6 μs. That result was obtained with the following specifications for the electrodes:

| | | |
|---|---|---|
| Radius of the outer electrode | 8.5 | cm |
| Radius of the inner electrode | 4.8 | cm |
| Length of electrodes | 16 | cm |
| Gap between electrodes | 3.7 | cm |

The maximum inductance of the electrodes with this specifications was determined to be 9.1 nH.

1-19. (canceled)

20. A device for the endogenous production of radioisotopes, particularly for PET, comprising:
a vacuum chamber, the inner surface of which at least partially treated to resist ion implantation, and inertised with respect to the nuclear reaction products,
a pair of coaxial cilindric electrodes placed inside said vacuum chamber,
a capacitor bank,
means to connect said capacitor bank to said electrodes to generate between the latter an electrical discharge, thus generating plasma of the Arc Discharge kind and creating conditions for the unfolding of nuclear reactions that generate radioisotopes, said means of connection comprising coaxial cables, in which are inserted fast switches having:
a nominal current no lesser than 50 kA
an inductance no larger than 50 nH
a closing time no larger than 50 ns
a jitter no larger than 2 ns and
a repetition capability of no less than 1 Hz.
means (10) attached to said vacuum chamber for the creation of a vacuum not higher than 10⁻⁶ Torr
means attached to said vacuum chamber for the insertion, after creating the vacuum, of at least one reaction gas at a pressure of about 10 Torr, apt to guarantee creation of the plasma during discharge and subsequent obtainment of confinement conditions of such plasma of the order of 10¹⁵ keV-s/cm3, and
means attached to said vacuum chamber for the extraction of gas and its storage into a gas-chromatographic cylinder.

21. A device according to claim 20 wherein the vacuum chamber is cylindrical and has one end closed by a spherical shell.

22. A device according to claim 20 wherein the inside of the vacuum chamber is lined with a ceramic layer.

23. A device according to claim 20 wherein the inside of the vacuum chamber is lined with a heavy metal of the group of vanadium.

24. A device according to claim 23 wherein the inside of the vacuum chamber is lined with vanadium.

25. A device according to claim 23 wherein the inside of the vacuum chamber is lined with tantalum.

26. A device according to claim 23 wherein the inside of the vacuum chamber is lined with tungsten.

27. A device according to claim 23 wherein the vacuum chamber has been at least partially coated with nickel.

28. A device according to claim 20 wherein it includes a collector comprising a pair of coaxial elements electrically connected to the two coaxial electrodes, to the outer coaxial element being connected the shield of the various coaxial cables, and to the inner coaxial element being connected the inner lead of the of the various coaxial cables after crossing the aforementioned outer coaxial element.

29. A device according to claim 28 wherein the overall inductance of the aforementioned collector does not exceed 50 nH.

30. A device according to claim 20 wherein to the vacuum chamber is attached a vacuum pump.

31. A device according to claim 20 wherein to the vacuum chamber is attached at least one source of reaction gas.

32. A device according to claim 31 wherein to the vacuum chamber is attached a mixer to which several sources of different reaction gases are connected.

33. A device according to claim 20 wherein to the vacuum chamber is attached an external circuit for the extraction of the gas, for its filtering to capture the radioisotopes, and for its reintroduction in the vacuum chamber after said capture.

34. A device according to claim 20 wherein to the vacuum chamber is attached a cooling circuit for the cryogenic extraction of the gas.
